(19) United States
(12) Patent Application Publication
(10) Pub. No.: US 2003/0200166 A1
(43) Pub. Date: Oct. 23, 2003

(54) Financial organizer and transaction tracking method

(76) Inventor: Elisa R. Schaub, Sunrise Beach, MO (US)

Correspondence Address: HARSHAW RESEARCH INCORPORATED, P O BOX 418, OTTAWA, KS, 66067, US

(21) Appl. No.: 10/435,006

(22) Filed: May 9, 2003

Related U.S. Application Data
(62) Division of application No. 09/584,435, filed on May 31, 2000.

(51) Int. Cl. G06F 17/60

(52) U.S. Cl. 705/36; 705/39

(57) ABSTRACT

A financial organizer includes a cover having portions foldable over one another, each portion including a slotted member. The organizer further includes a card holding assembly having a plurality of card holders. The card holding assembly includes an insertion member for reception within a slotted member of a cover portion. The organizer includes an information pad including a first plurality of sheets having rows labeled with credit card data headings and a second plurality of sheets labeled with credit card transaction categories. Account data pertinent to particular credit cards held within the card assembly is recorded on respective sheets of the first plurality of sheets. Credit card transactional data pertinent to particular cards is recorded on respective sheets of the second plurality of sheets, a portion of which are interposed between each of the first plurality of sheets.

### RELATED APPLICATIONS

This application is a divisional application claiming the priority date of the prior filed parent application Ser. No. 09/584,435, filed May 31, 2000.

### BACKGROUND OF THE INVENTION

This invention relates generally to financial organizing systems and, more particularly, to a financial organizer and method for financial planning and credit card transaction tracking.

Many individuals in today's society carry multiple credit cards issued by different lending institutions and having varying credit limits and credit terms. It is difficult for such an individual to keep track of each account, its credit terms and limit, and the present account balance. Garnering the pertinent account information is also difficult if a particular credit card becomes lost or stolen. Further, having knowledge of credit card limits and terms is insufficient unless coupled with knowledge of how one's positive cash flow may be affected by an additional credit purchase.

Various wallet organizers and financial planners have been proposed in the prior art for assisting in the budget process. While assumably effective for their intended purposes, such devices and methods do not provide for a convenient, up-to-date, “at-a-glance” look at one's financial circumstance so as to determine both the feasibility of a proposed purchase and the desirability of using a particular credit card to consummate the purchase.

### SUMMARY OF THE INVENTION

A financial organizer according to the preferred embodiment of the present invention includes a flexible cover having first and second portions foldable generally in half over one another and each portion including a slotted member. The financial organizer further includes a card holding assembly having a plurality of card holders of a transparent material. Each card holder includes a front panel and a rear panel, each panel having opposite sides and opposite edges. The front and rear panels of each card holder are joined together along selected opposite edges and sides so as to define a card receiving pocket therebetween. Each holder also defines a card insertion opening. A flexible insert member depends from a common side or edge of each card holder and is slidably receivable within the slotted member of the first portion of the cover.

The financial organizer further comprises an information pad including a first and second plurality of sheets. Each of the first plurality of sheets includes rows labeled with credit card data headings indicative of account information, said data headings including credit card issuer, last four digits of account number, expiration date, issuer's address, issuer's phone number, grace period, credit limit, cash adv. fee, late pmt. fee, over-credit-limit fee, APR, positive cash flow, and savings. Each of the first plurality of sheets corresponds with a credit card held within the card holding assembly. Therefore, information unique to the credit account represented by a credit card may be recorded on a corresponding sheet of the first plurality of sheets.

Each of the second plurality of sheets include columns labeled with credit card transaction tracking categories indicative of various credit account events, said tracking categories including transaction date, transaction description, transaction amount, place of transaction, tax, credit/return, credit card payment, current statement balance, and finance charge. Therefore, each of the credit events, transactions, or related descriptions may be recorded on appropriate transaction sheets corresponding to a particular credit card. An essential novelty of this invention is that a predetermined number of sheets of the second plurality of sheets are interposed between each of the first plurality of sheets such that multiple transactions relative to a respective credit card may be recorded thereon. A second insertion member is attached to the information pad for insertion into the slotted member of the second portion of the cover.

A method for using the financial organizer for financial planning and tracking credit card transactions includes the steps of calculating a user's monthly positive cash flow by subtracting fixed monthly expenses from the user's net income. This amount is recorded on each of the first plurality of sheets. The total dollar amount of the user's savings is also recorded on each of these sheets. Account-type data pertinent to credit cards held within the card holders of the card holding assembly may be recorded on respective sheets of the first plurality of sheets. Specific transactions related to a credit card, namely those transactions indicated by the transaction categories, may be recorded on sheets of the second plurality of sheets corresponding to that credit card.

Accordingly, a user may review the sheets of the information pad prior to engaging in a credit card purchase transaction to determine if the transaction is feasible at all, and, if so, which credit card would be preferable to use.

Therefore, a general object of this invention is to provide a financial organizer which can record and track credit card spending.

Another object of this invention is to provide a financial organizer, as aforesaid, which can be used to reconcile actual credit card transactions with monthly credit card statements.

Another object of this invention is to provide a financial organizer, as aforesaid, which can be used to compare credit card debt with a user's positive cash flow and savings.

Still another object of this invention is to provide a financial organizer, as aforesaid, which can display the credit limit and credit terms of multiple credit cards.

Yet another object of this invention is to provide a financial organizer, as aforesaid, which provides for the daily recording and accounting of credit card events and transactions.

A further object of this invention is to provide a financial organizer, as aforesaid, which is pocket sized and able to hold multiple credit cards and record keeping sheets.

A still further object of this invention is to provide a financial organizer, as aforesaid,

Other objects and advantages of this invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of the financial organizer according to a preferred embodiment of the present invention;

FIG. 2 is a perspective view of the financial organizer as in FIG. 1 with a data sheet of the information pad in a raised configuration to show a transaction sheet therebelow;

FIG. 3 is a perspective view of an alternative embodiment of the financial organizer showing a front side of a first holder page;

FIG. 4 is a perspective view of the financial organizer as in FIG. 3 with the first holder page pivoted to show the front side of a transaction sheet;

FIG. 5a is a front view of a holding page for placement into the financial organizer of FIG. 3;

FIG. 5b is a front view of a credit card and a data sheet removed from a holder page;

FIG. 5c is a front view of a third type of recording sheet for storage away from the financial organizer; and

FIG. 5d is a front view of a transaction sheet for placement in the financial organizer of FIG. 3.

### DESCRIPTION OF THE PREFERRED EMBODIMENT

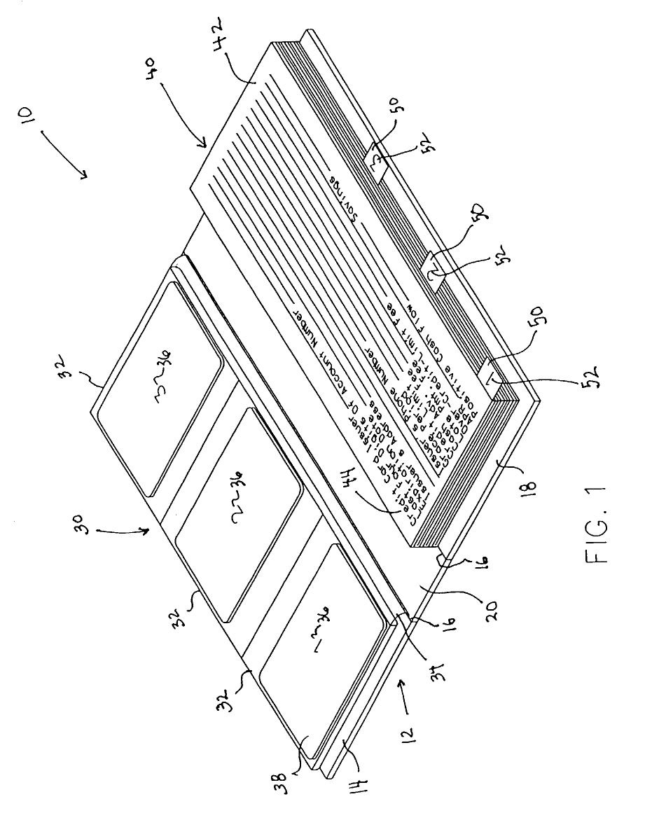

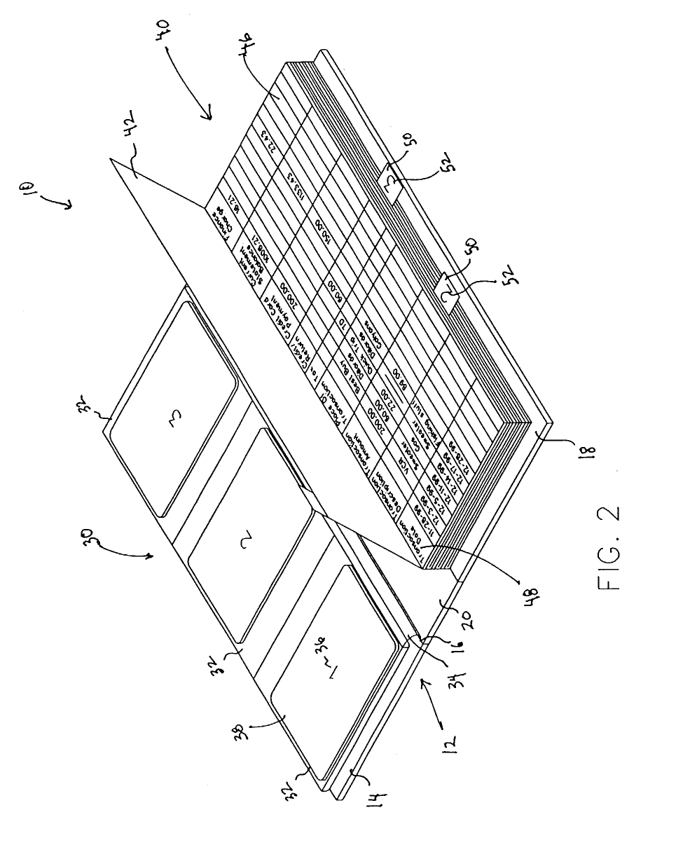

A financial organizer 10 and a method for its use in financial planning and tracking credit card transactions according to a preferred embodiment of the present invention will now be described with reference to FIGS. 1-2 of the drawings.

The financial organizer 10 comprises a substantially rectangular cover 12 constructed of a flexible material such as leather, plastic, or the like. The cover 12 includes first 14 and second 18 portions separated by a foldable portion 20 which forms a longitudinal axis between the portions about which the first 14 and second 18 portions may be folded upon one another. The first 14 and second 18 portions comprise slotted members having inner and outer planar surfaces defining a pocket therebetween and having a slot 16 adjacent the foldable portion 20 of the cover 12 such that insertion members may be received within the pockets, as to be more fully described below.

The financial organizer 10 further includes a card holding assembly 30 constructed of transparent material and having a plurality of connected card holders 32. Each card holder 32 includes a front panel and a rear panel, each panel having opposite sides and opposite edges. The front and rear panels are joined together along predetermined opposite edges and sides so as to define a card-receiving pocket therebetween. Each holder 32 further includes an open edge defining a card-insertion opening for receiving a credit card 38 into the pocket. A first flexible insertion member 34 is attached to the card holding assembly 30 along a longitudinal edge thereof adjacent the foldable portion 20 of the cover 12 and is receivable through the slot 16 in the insertion member of the first portion 14. Thus, the card holding assembly 30 is removably coupled to the first portion 14. Each card holder 32 includes a number 36 imprinted thereon corresponding to a number on an index tab, as to be more fully described later.

The financial organizer 10 further includes an information pad 40 having a plurality of credit card data sheets 42 and a plurality of credit card transaction sheets 46. A rear longitudinal edge of each sheet is coupled to a rear backing (not shown) of adhesive-like material such that the sheets are movable in book-like fashion about a central axis defined by the backing. Multiple transaction sheets 46 are interposed between each data sheet 42. An index tab 50 extends from each of the data sheets 42 and includes a number 52 imprinted thereon corresponding to a number 36 imprinted on a card holder 32. A second insert member (not shown) identical to the first insert member 34 depends from the rear backing and is insertable within the slot 16 of the slotted member of the second portion 18 of the cover 12. Thus, the information pad 40 is removably coupled to the financial organizer 10.

Each of the data sheets 42 includes rows labeled with credit card data headings 44 including credit card issuer, last four digits of account number, expiration date, issuer's address, issuer's phone number, grace period, credit limit, cash adv. fee, late pmt. fee, over-credit-limit fee, APR, positive cash flow, and savings. Data responsive to each of these headings 44 and relating to a card held within a card holder 32 that bears a number 36 corresponding to a number 52 on the index tab 50 extending from the sheet is recorded thereon. In addition, a positive cash flow amount is calculated by subtracting a user's fixed monthly expenses from the user's net income. A user's total savings is also recorded.

Each of the transaction sheets 46 includes columns labeled with credit card transaction categories 48 including transaction date, transaction description, transaction amount, place of transaction, tax, credit/return, credit card payment, current statement balance, and finance charge. Data responsive to these categories 48 may be recorded in the appropriate columns every time a credit card transaction or account event occurs relative to a corresponding card and corresponding data sheet 42. As a predetermined number of transaction sheets are interposed between each data sheet, transactions or account events may be recorded potentially for several months before a replacement information pad 40 is needed. In addition, this interpositional configuration allows transactions to be recorded in convenient proximity to the appropriate data sheet associated with a corresponding credit card.

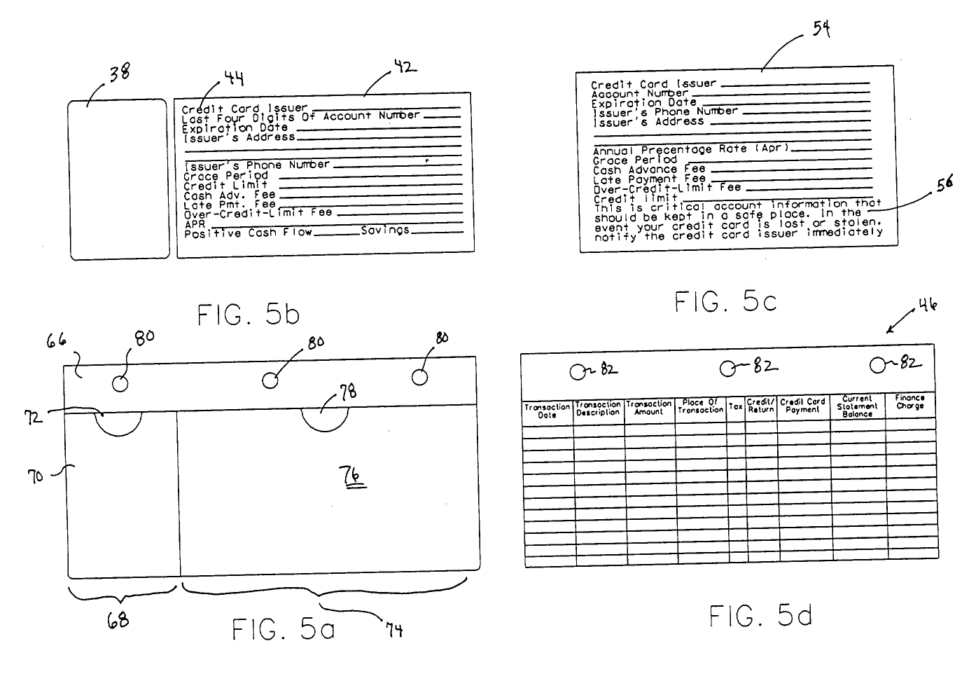

The financial organizer 10 further includes a plurality of a third type of sheets 54 that is very similar to the data sheets 42. As shown in FIG. 5c, the third type of sheet 54 includes substantially all of the same credit card data headings 44 as the first type, but also includes a statement 56 admonishing a user to record the requested data on the sheet and then to store it in a safe place. Therefore, if the organizer itself becomes lost or is destroyed, the user may consult the third type of sheet 54 for important account information.

The financial organizer 10 may be used for financial planning related to consumer credit purchases and for assessment of how a proposed credit purchase may affect an individual's overall cash flow. According to this method, a user conducts a basic personal budget analysis, including calculation of monthly positive cash flow. This monthly cash flow amount may be calculated by subtracting all monthly budgetary expenses from the user's monthly net income. This amount is recorded adjacent the positive cash flow heading on each of the data sheets 42. The total amount of money held in savings by the user is also recorded on each data sheet 42. Data pertinent to the account of a particular credit card 38 held within the organizer 10 is recorded on corresponding data sheets. Data pertinent to credit card transactions is recorded on appropriate transaction sheets 46 such that a current balance is always available for review by the user.

When considering a proposed credit purchase transaction, a user estimates the potential increase in the monthly payment that would be required if any of the credit cards held in the organizer 10 were used to make the purchase. The user then compares the monthly cash flow amount, which is recorded on each data sheet, with this proposed increase in expenses so as to determine the feasibility of the purchase. The amount of savings may be added to the positive cash flow amount prior to making a comparison with the estimated increase in expenses.

Once the feasibility of a purchase is determined, the user must choose which credit card 38 to use in consummating the purchase. Accordingly, the user adds the amount of the proposed purchase to the current balance of each credit card as shown on appropriate transaction sheets 46. These potential new balances are then compared to the credit limits recorded on respective data sheets 42. An additional review is made of the annual percentage rate and fees related to the various credit cards 38 in order to finally decide which card is most economically advantageous to use.

Faithful use of the financial organizer 10 is also useful for reconciling monthly credit card statements. The organizer 10 may provide a more detailed reminder as to when and where certain credit purchases were made as well as to allow the user to scrutinize the correctness of the credit card statement. This is helpful in that purchases not made by the user are sometimes inadvertently or mistakenly applied to the user's account.

Accordingly, it can be seen that use of the financial organizer 10 allows a user to keep a daily balance relative to credit card transactions and events and to use that information in conjunction with a positive cash flow amount so as to evaluate the feasibility of credit purchases, limit over-spending, and maintain up-to-date credit card account information.

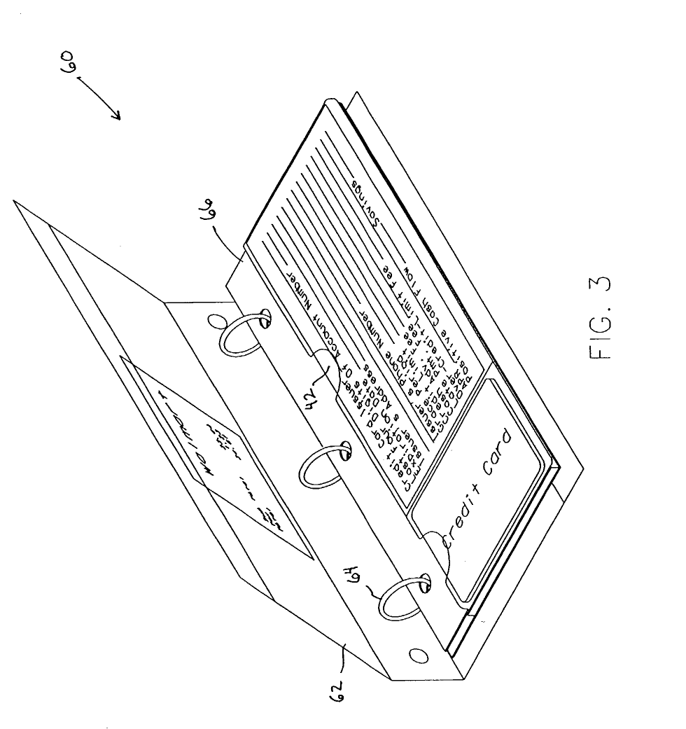

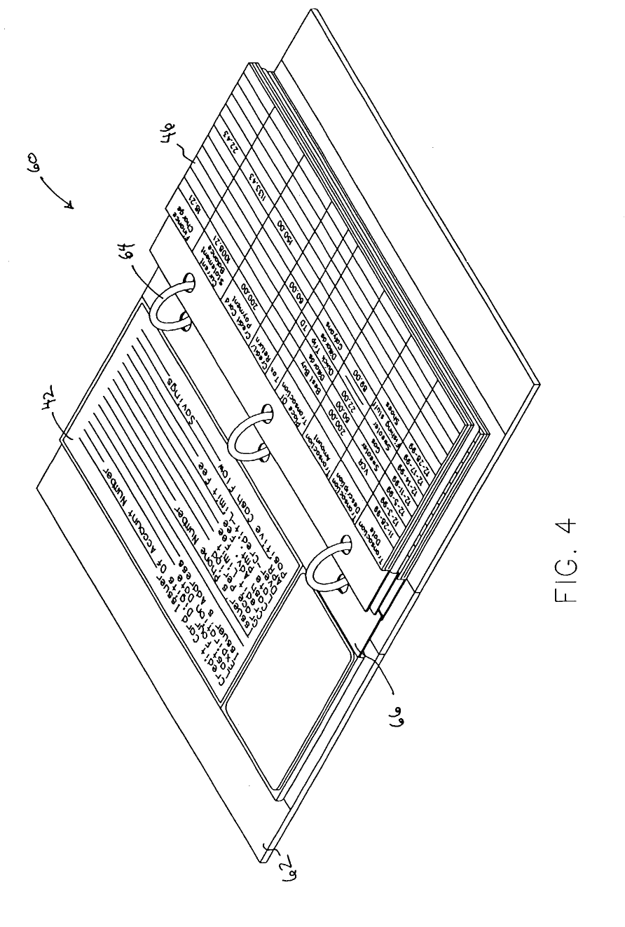

An alternative embodiment 60 of the financial organizer is shown in FIGS. 3-5 and is very similar to the preferred embodiment except as specifically noted below. The alternative embodiment 60 includes a three-ring binder cover 62 which includes three spaced apart rings 64 for holding sheets therein, as is known in the art. The alternative embodiment 60 includes a plurality of holder pages 66, each page having a first segment 68 defining a card-receiving pocket 70 with a card insertion opening 72. Each page 66 further includes a second segment 74 defining a card-receiving pocket 74 at least twice the longitudinal extent of the card receiving pocket 70 of the first segment 68 and having a card insertion opening 78. Therefore, each page 66 is configured to receive a credit card 38 and a corresponding data sheet 42. Each page 66 includes spaced apart apertures 80 suitable to mate with the rings 64 of the three-ring binder 62. The alternative embodiment 60 of the financial organizer further includes transaction sheets having spaced apart apertures 82 suitable to mate with rings 64 of the three-ring binder 62. The alternative embodiment 60 of the financial organizer may be used according to the method described previously.

It is understood that a spiral binder could also be utilized to connect the plurality of data and transaction sheets. It should also be appreciated that this entire financial organizer and method of tracking credit card transactions may be embodied in a portable computer system having sufficient memory to store all of the data contemplated above. The portable computer system would allow entry of credit transaction information and would calculate new or potential balances accordingly. According to a computerized embodiment, each sheet would be a selectable and modifiable screen display. It is further contemplated that the method disclosed herein could be implemented as software for personal computers or even in business applications. Existing financial software could also be modified to include the novel features of this invention.

It is understood that while certain forms of this invention have been illustrated and described, it is not limited thereto except insofar as such limitations are included in the following claims and allowable functional equivalents thereof.

Having thus described the invention, what is claimed as new and desired to be secured by Letters Patent is as follows:

1. A financial organizer for holding credit cards and for recording credit information, comprising:
a substantially rectangular cover of flexible material having first and second portions foldable generally in half about an axis extending longitudinally between said first and second portions, each portion including a slotted member;
a card assembly including a plurality of card holders of a transparent material, each card holder including:
a front panel having opposite sides and opposite edges;
a rear panel having opposite sides and opposite edges and being joined to said front panel along selected opposite edges and sides to define a card-receiving pocket therebetween;
each of said holders defining a card insertion opening;
a first flexible insert member attached to a common side of each said card holder, said first insert member adapted to be received within said slotted member of said first portion of said cover;
an information pad, comprising:
a first plurality of flexible sheets having rows labeled with credit card data headings, said data headings including credit card issuer, last four digits of account number, expiration data, issuer's address, issuer's phone number, grace period, credit limit, cash advance fee, late payment fee, over-credit-limit fee, APR, positive cash flow, and savings, each of said first plurality of sheets including an index tab having a number imprinted thereon which corresponds to a number on a respective card holder for conveniently accessing a desired sheet of said first plurality of sheets corresponding to a selected credit card;
means for securing said first plurality of sheets for movement about a central axis in book-like fashion;
a second plurality of flexible sheets having columns labeled with credit card transaction tracking categories, said transaction categories including transaction date, transaction description, transaction amount, place of transaction, tax, credit/return, credit card payment, current statement balance, and finance charge, a predetermined number of said second plurality of sheets being interposed between each of said first plurality of sheets for association with and convenient proximity to corresponding sheets of said first plurality of sheets;
said securing means securing said second plurality of sheets for movement about said central axis in book-like fashion;
a second flexible insert member attached to said securing means, said second insert member adapted to be received within said slotted member of said second portion of said cover;
wherein each said card holder includes a number imprinted thereon and each of said first plurality of sheets includes an index tab having a number imprinted thereon which corresponds to a number on a respective card holder, whereby said information pad may be opened directly to a sheet of said first plurality of sheets corresponding to a selected credit card;
a third plurality of sheets separate from said cover, card assembly, and information pad, said third plurality of sheets having rows labeled with credit card data headings substantially similar to said credit card data headings on said first plurality of sheets, each sheet of said third plurality of sheets including indicia admonishing a user to record the requested data and store said each sheet in a safe place.

2. A financial organizer as in claim 1 wherein said securing means includes an adhesive backing connected to common longitudinal edges of said first and second plurality of sheets.

3. A financial organizer as in claim 1 wherein said securing means includes a three-ring binder having spaced apart rings and each of said first and second plurality of sheets includes a plurality of apertures adjacent an edge thereof through which respective rings of said three-ring binder extend.

4. A financial organizer as in claim 1 wherein said securing means includes a spiral member and each of said first and second plurality of sheets has a plurality of apertures adjacent an edge thereof through which said spiral member extends.

5. A financial organizer as in claim 1 wherein said cover is constructed of a plastic material, said cover having a fold portion such that said first portion is foldable upon said second portion.

6. A financial organizer as in claim 1 wherein each said slotted member of said first and second portions of said cover is adjacent said axis between said first and second portions.

7. A financial organizer for holding credit cards and for recording credit information, comprising:
a substantially rectangular cover of flexible material having first and second portions foldable generally in half about an axis extending longitudinally between said first and second portions, each portion including a slotted member;
a card assembly including a plurality of card holders of a transparent material, each card holder including:
a front panel having opposite sides and opposite edges;
a rear panel having opposite sides and opposite edges and being joined to said front panel along selected opposite edges and sides to define a card-receiving pocket therebetween;
each of said holders defining a card insertion opening;
a first flexible insert member attached to a common side of each said card holder, said first insert member adapted to be received within said slotted member of said first portion of said cover;
an information pad, comprising:
a first plurality of flexible sheets having rows labeled with credit card data headings, each of said first plurality of sheets including an index tab having a number imprinted thereon which corresponds to a number on a respective card holder for conveniently accessing a desired sheet of said first plurality of sheets corresponding to a selected credit card;
means for securing said first plurality of sheets for movement about a central axis in book-like fashion;
a second plurality of flexible sheets having columns labeled with credit card transaction tracking categories, a predetermined number of said second plurality of sheets being interposed between each of said first plurality of sheets for association with and convenient proximity to corresponding sheets of said first plurality of sheets;
said securing means securing said second plurality of sheets for movement about said central axis in book-like fashion;
a second flexible insert member attached to said securing means, said second insert member adapted to be received within said slotted member of said second portion of said cover;
wherein each said card holder includes a number imprinted thereon and each of said first plurality of sheets includes an index tab having a number imprinted thereon which corresponds to a number on a respective card holder, whereby said information pad may be opened directly to a sheet of said first plurality of sheets corresponding to a selected credit card.

8. A financial organizer as in claim 7 further comprising a third plurality of sheets separate from said cover, card assembly, and information pad, said third plurality of sheets having rows labeled with credit card data headings substantially similar to said credit card data headings on said first plurality of sheets, each sheet of said third plurality of sheets including indicia admonishing a user to record the requested data and store said each sheet in a safe place.

9. A financial organizer as in claim 7 wherein said securing means includes an adhesive backing connected to common longitudinal edges of said first and second plurality of sheets.

10. A financial organizer as in claim 7 wherein said securing means includes a three-ring binder having spaced apart rings and each of said first and second plurality of sheets includes a plurality of apertures adjacent an edge thereof through which respective rings of said three-ring binder extend.

11. A financial organizer as in claim 7 wherein said securing means includes a spiral member and each of said first and second plurality of sheets has a plurality of apertures adjacent an edge thereof through which said spiral member extends.

12. A financial organizer as in claim 7 wherein said cover is constructed of a plastic material, said cover having a fold portion such that said first portion is foldable upon said second portion.

13. A financial organizer as in claim 7 wherein each said slotted member of said first and second portions of said cover is adjacent said axis between said first and second portions.

14. A financial organizer as in claim 7 wherein said credit card data headings are labeled credit card issuer, last four digits of account number, expiration date, issuer's address, issuer's phone number, grace period, credit limit, cash adv. fee, late pmt. fee, over-credit-limit fee, APR, positive cash flow, and savings, whereby information pertinent to a particular credit card may be recorded on a respective sheet of said first plurality of sheets.

15. A financial organizer as in claim 7 wherein said credit card transaction tracking categories are labeled transaction date, transaction description, transaction amount, place of transaction, tax, credit/return, credit card payment, current statement balance, and finance charge, whereby credit card transaction information corresponding to a particular credit card may be recorded on a respective sheet of said second plurality of sheets.
